(19) United States
(12) Patent Application Publication
(10) Pub. No.: US 2024/0335883 A1
(43) Pub. Date: Oct. 10, 2024

(54) BUILD PLATE WITH INTEGRATED COOLING CHANNELS

(71) Applicant: Freeform Future Corp., Hawthorne, CA (US)

(72) Inventors: Daniel Roszhart Zehr, Erie, CO (US); Tasso Lappas, Pasadena, CA (US)

(21) Appl. No.: 18/629,527

(22) Filed: Apr. 8, 2024

Related U.S. Application Data
(60) Provisional application No. 63/458,373, filed on Apr. 10, 2023.

(51) Int. Cl. B22F 12/30; B22F 10/30; B22F 12/90; B33Y 10/00; B33Y 30/00; B33Y 50/02

(52) U.S. Cl. CPC B22F 12/30; B22F 10/30; B22F 12/90; B33Y 10/00; B33Y 30/00; B33Y 50/02; B22F 2203/00; B22F 2998/10

(57) ABSTRACT

This application describes a build plate having integrally formed channels for cooling the build plate during additive manufacturing or 3D printing. The build plate may include a bottom portion (e.g., base, section, half, etc.) and a top portion (e.g., top, section, half, etc.). The top portion is formed, via additive manufacturing, onto the bottom portion. The top portion includes channels that are configured to receive coolant, gases, or other fluids to provide cooling effects to the build plate during manufacturing of a part on the build plate. The use of the channels may result in increased heat dissipation, improved throughput, precision, and/or efficiencies in additive manufacturing.

### CROSS-REFERENCE TO RELATED APPLICATIONS

This application claims priority to U.S. Provisional Application No. 63/458,373, filed Apr. 10, 2023, entitled “Build Plate with Integrated Cooling Channels,” the entirety of which is herein incorporated by reference.

### BACKGROUND

Additive manufacturing or 3D printing offers multiple benefits over traditional manufacturing processes. For example, additive manufacturing allows for more complex parts to be manufactured, eliminating many of the design constraints of previous manufacturing processes. Additionally, additive manufacturing can reduce material cost and/or waste. However, currently, print times can be relatively long and throughput for existing additive manufacturing systems can be lower compared to conventional manufacturing processes. Also, additive existing additive manufacturing techniques have not been as robust, stable, and/or repeatable as conventional manufacturing processes. Accordingly, there is a need for improvements to additive manufacturing processes and techniques.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates a perspective view of an example build plate having example integrated cooling channel(s) for providing cooling during manufacture of a part, according to an example of the present disclosure.

FIG. 2A illustrates a top view of the build plate of FIG. 1, according to an example of the present disclosure.

FIG. 2B illustrates a bottom view of the build plate of FIG. 1, according to an example of the present disclosure.

FIG. 3A illustrates a first side view of the build plate of FIG. 1, according to an example of the present disclosure.

FIG. 3B illustrates a second side view of the build plate of FIG. 1, according to an example of the present disclosure.

FIG. 3C illustrates a third side view of the build plate of FIG. 1, according to an example of the present disclosure.

FIG. 3D illustrates a fourth side view of the build plate of FIG. 1, according to an example of the present disclosure.

FIG. 4A illustrates a first cross-sectional isometric view of the build plate of FIG. 1, taken along line A-A of FIG. 2A, according to an example of the present disclosure.

FIG. 4B illustrates a second cross-sectional planar view of the build plate of FIG. 1, taken along line A-A of FIG. 2A, according to an example of the present disclosure.

FIG. 5A illustrates a top view of a bottom portion of the build plate of FIG. 1, according to an example of the present disclosure.

FIG. 5B illustrates a bottom view of the bottom portion of the build plate of FIG. 5A, according to an example of the present disclosure.

FIG. 6 illustrates a bottom view of a top portion of the build plate of FIG. 1, according to an example of the present disclosure.

FIG. 7A illustrates a first cross-sectional view of the top portion of FIG. 6, taken along line B-B of FIG. 6, according to an example of the present disclosure.

FIG. 7B illustrates a second cross-sectional view of the top portion of FIG. 6, taken along line C-C of FIG. 6, according to an example of the present disclosure.

FIG. 8 illustrates the build plate of FIG. 1 usable within an example build module, according to an example of the present disclosure.

FIG. 9 illustrates an example process to form channel(s) within a build pate, according to an example of the present disclosure.

### DETAILED DESCRIPTION

This application is directed, at least in part, to a build plate having integrally formed channel(s)for cooling the build plate during additive manufacturing or 3D printing, according to examples of the present disclosure. In some instances, the build plate may include a bottom portion (e.g., base, section, half, etc.) and a top portion (e.g., top, section, half, etc.). In some instances, the bottom portion may be formed using conventional manufacturing techniques (e.g., forging, casting, stamping, machining, etc.) or via additive manufacturing. In some instances, the top portion may be formed, via additive manufacturing, onto the bottom portion. For example, the bottom portion of the build plate may be installed in an additive manufacturing system, such as a build module of a 3D printing system, and the top portion of the base plate may be additively manufactured directly or indirectly onto a surface of the bottom portion. Channel(s) may be formed in the top portion during manufacturing of the bottom portion. The channel(s)formed in the top portion of the build plate are configured to receive coolant (e.g., liquid, gas, or other fluids) to provide cooling effects to the build plate and/or a part during manufacturing of the part on the build plate. The channel(s) may be formed with any desired characteristic(s) (e.g., depth, cross-section, shape, etc.), and in some instances, the characteristic(s) of the channel(s) may be based on specifics of part(s) being manufactured on the build plate (e.g., size, shape, material, volume, footprint, quantity, etc.). The use of the channel(s) may result in increased heat dissipation, more uniform temperature control of the build plate, improved throughput, precision, and/or efficiencies in additive manufacturing.

In additive manufacturing, which may also be referred to as powder-bed fusion, powdered metal is selectively melted using lasers (e.g., laser beam, electron beam, thermal print head, etc.) or other heat sources. In some instances, the build plate is disposed within a build module of the 3D printing system. For example, the build plate may be disposed within a cavity of the build module. The powdered metal may be disposed on the build plate, within the cavity, and may be deposited (e.g., recoated) as the lasers melt the powdered metal. The build module may be moved (e.g., by a conveyor system/assembly) into and out of a build area that may be acted on by the lasers. During manufacturing of the part, the lasers are directed to certain locations on the bed of powdered metal to melt the powdered metal. The powdered metal is contained within the build module as the layers of powdered metal are deposited onto previous (now melted) layers. This process may repeat until a part, layer by layer, is manufactured, during which the build plate may retract into the cavity.

As introduced above, the build plate may include different portions. The bottom portion may represent a base of the build plate. The bottom portion may include a bottom surface that couples to piston(s), jack(s), or other lift mechanism(s) that adjust a height of the build plate within the cavity of the build module. For example, as the layers of the powdered metal are melted, the piston(s) may lower the build plate further into the cavity of the build module as layers of the powdered metal are deposited. The top portion, which may represent a top of the build plate, may be formed on a top surface of the bottom portion. The top portion may include a bottom surface that is formed on the top surface of the bottom portion, and a top surface onto which the powdered metal is deposited, or on which the part is manufactured. For example, the part may be manufactured on the top surface of the top portion.

The top portion may be formed, layer by layer, as powdered metal is deposited onto the top surface of the bottom portion (or a previously deposited layer) and melted via the lasers. In turn, the top portion may be formed on the bottom portion, and once the top portion is manufactured, the build plate may be used to manufacture parts. For example, once the top portion is manufactured, part(s) may be manufactured on top of the top portion. In some instances, prior to manufacturing the top portion on the bottom portion, the bottom portion may be finished (e.g., machined, ground, polished, cleaned, etched, etc.) to ensure a desired levelness and/or surface finish of the top surface of the bottom portion. For example, the top surface of the bottom portion may be ground flat to provide a level surface upon which the top portion is manufactured via additive manufactured. Alternatively, the top surface of the bottom portion may not have to be planar, as the top portion being manufactured using additive manufacturing may account for any irregularities in the bottom portion. Finishing the top surface of the bottom portion may also serve to increase adhesion between the top portion and the bottom portion.

In some instances, the channel(s) are formed within the top portion during manufacturing of the top portion. For example, as the layers of the top portion are manufactured, the channel(s) may be formed within the top portion. Powdered metal within areas of the top portion that correspond to the channel(s) may not be melted by the lasers. The lasers may melt powdered metal to form sidewalls, a top, etc. of the channel(s). After manufacturing the top portion, liquid, gas, and/or other fluids may be used to flush the powdered metal from within the channel(s). Thereafter, the channel(s) may receive the coolant for providing cooling effects during manufacturing of the part(s).

The channel(s) may take any path within the top portion, such as a serpentine path, a zig-zag like path, a spiral path, and so forth. In some instances, the characteristic(s) of the channel(s), such as a geometry, size, shape, path, and/or configuration may be customized to particular part(s) being additively manufactured on the build plate. For example, depending upon the part(s) to be manufactured on the build plate, the channel(s) may be configured accordingly. Specific(s) of the part, such as size, material, an amount of energy used during manufacture, etc., may be used to determine the characteristic(s) of the channel(s). The characteristic(s) of the channel(s) may also be based on characteristic(s) of the 3D printing system (e.g., a size of build module, etc.). Once the desired characteristic(s) are determined, the channel(s) may be manufactured accordingly.

The bottom portion may include one or more inlet(s) and one or more outlet(s) for supplying coolant to, and receiving coolant from, the channel(s), respectively. The channel(s) formed within the top portion fluidly connect to the one or more inlet(s) and the one or more outlet(s). For example, when forming the channel(s), or more generally the top portion, the channel(s) may extend from (e.g., start from) the one or more inlet(s), and extend to (e.g., end at) the one or more outlet(s). Between the one or more inlet(s) and the one or more outlet(s), the channel(s) may take any path.

The one or more inlet(s) may supply the coolant to the channel(s), while the one or more outlet(s) may receive the coolant (after passing through the build plate). The coolant supplied to the build plate may be conditioned via one or more heat exchangers, or may be supplied via one or more tanks (e.g., liquid nitrogen). Various hoses, valves, pumps, and so forth may be fluidly connected to the inlet(s) and outlet(s) for supplying the coolant and/or controlling a flow rate of the coolant through the channel(s). The hoses, for example, may be configured to extend and retract, telescope, etc. during raising and lowering of the build plate and while the part(s) are manufactured. Example hoses include bellowed hoses, serpentine coils, telescoping hoses, elastomeric hoses, etc. In some instances, the individual build modules may include cooling systems for supplying the coolant, or the build modules may fluidly connect to other systems within an environment for receiving the coolant.

In some instances, the bottom portion includes a single inlet and a single outlet. In such instances, the channel(s) formed within the top portion may include a single inlet that fluidly connects with the inlet of the bottom portion, and a single outlet that fluidly connects with the outlet of the bottom portion. However, in some instances, more than one inlet and/or outlet may be formed in the bottom portion. In such instances, respective inlets and outlets may fluidly connect (e.g., manifold). Moreover, the top portion may include a single continuous channel that routes throughout the top portion, or different and distinct (e.g., fluidly separate) channels. The distinct channels may each have a respective inlet and outlet, and the distinct channels may be sized, shaped, configured similarly or differently. However, in some instances, the inlet may branch into multiple channel(s).

In some instances, the different channels may be the same or differently sized (e.g., in length, cross-sectional dimension, etc.) and/or shaped. In some instances, the different channels may be formed within different areas of the top portion. For example, a first channel may be disposed within, throughout, etc. a first area of the top portion, while a second channel may be disposed within, throughout, etc. a second area of the top portion. In some instances, the first area and the second area may be non-overlapping. The first channel may include characteristic(s) (e.g., size, shape, dimension(s), etc.) for part(s) manufactured within the first area, while the second channel may include characteristic(s) for part(s) manufactured within the second area. As another example, a first channel may route around a perimeter of the top portion, while a second channel may be formed closer to a center (e.g., interior to) the second channel. In some instances, the channel(s) may be vertically disposed relative to one another (e.g., on top of one another). The use of different channels may be used to cool different areas of the build plate more effectively, for example, depending upon the heat generated during manufacturing of the parts on the build plate, respectively. The flow rates of the coolant through the channels may be similar or different, and/or the coolant used within the channel may be similar or different.

The bottom portion and the top portion may be manufactured from suitable materials (e.g., metallurgically compatible). For example, in order for the top portion to bind (e.g., attach, secure, etc.) to the bottom portion during manufacturing, a suitable powdered metal may be chosen for manufacturing the top portion. As an example, the bottom portion may be formed from steel, while the top portion may be formed from aluminum. In some instances, the materials used to form the top portion and/or the bottom portion may be dependent upon the powdered metal that is to be used to manufacture the part(s), once the build plate is manufactured. Moreover, in some instances, the bottom portion may be manufactured from a material that, at increased temperatures, is of a higher strength than compared to the top portion. For example, the bottom portion may be manufactured from Inconel 718 while the top portion may be manufactured from 316L stainless steel.

In some instances, given that the bottom portion may be formed of a higher strength material than the top portion, if any yielding to the build plate occurs during manufacture of the part(s), the build plate may be reheated to correct any planarity or distortion issues. For example, during reheating, the lower strength material of the top portion may yield to the higher strength material of the bottom portion.

After a part is manufactured on the build plate, the part may be removed from the build module. In some instances, prior to the build plate being used to manufacture another part (or after using the build plate to manufacture a threshold number of parts), the top surface of the top portion may be resurfaced (e.g., machined flat). For example, the conditions experienced by the build plate during manufacturing of the part(s) may cause portions of the build plate to deflect (e.g., bow, bend, flex, yield, etc.), have defects (e.g., burn marks), etc. Deflections may result in a non-planar building surface, and manufacturing additional parts on the build plate may lead to irregularities, errors, etc. In some instances, to correct any planarity issues before manufacturing another part, the top surface of the top portion may be machined planar. The top portion may include a sufficient thickness to permit the top surface to be machined and without puncturing the channel(s). In other instances, additional layer(s) of material may be manufactured onto the top surface of the top portion to build up material in order for the top portion to be machined. The additional layer(s) may be machined flat, or may be manufactured flat. Alternatively, additional layer(s) of material may be deposited onto the top surface of the top portion to build up material and make the top surface of the top portion flat. Still in some instances, the top portion may be removed and another top portion may be built on the bottom portion. This may also occur, for example, when channel(s) with different characteristic(s) are demanded.

Although the discussion herein is with regard to forming the channel(s) within the top portion, in some instances, the channel(s) may additionally or alternatively be formed within the bottom portion, or in a third portion below the bottom portion. For example, the channel(s) may be etched or milled within the bottom portion. In some instances, the bottom portion may include a first half, section, or portion of the channel(s), and the top portion may include a second half, section, or portion of the channel(s) that align, engage, etc. with the first half of the channel(s) in the bottom portion. Here, two portions of material (e.g., the bottom portion and the top portion) may come together to form the channels in the build plate. For example, the bottom portion may include a first half of the channel(s), and the top portion may be formed on the bottom portion, creating the second half of the channel(s) in the process. Moreover, although the discussion is with regard to forming the top portion, and the channel(s), using additive manufacturing, in some instances, the channel(s) in the top portion may be milled or etched. In some instances, the top portion may be adhered, fastened, or otherwise coupled to the bottom portion.

In some instances, sensor(s) (e.g., cameras, strain gauges, temperature sensor(s), vibration sensor(s), etc.) may be used to determine whether the top portion needs to be resurfaced, built up, or replaced after manufacturing part(s), as well as monitor conditions experienced during manufacturing of the part(s). For example, the sensor(s) may be used to measure a temperature associated with manufacturing the part(s), a temperature of the top surface of the top plate, a temperature of the coolant within the channel(s), a deflection of the build plate, or other characteristic(s) of the build plate and/or the build module. In some instances, sensor data (e.g., feedback) generated by the sensor(s) may be used to control one or more operations during manufacturing of the part(s), in real-time, such as adjusting a flow rate of the coolant through the channel(s), reducing an intensity of the lasers melting the powdered metal, and so forth.

The sensor data may also be used to assist in determining whether top portion needs to be resurfaced or replaced. For example, determinations may be made based on the number of times the build plate has been used, the amount of time the build plate has been used, the energy used to melt the powdered metal, and so forth. If the amount of time is greater than a threshold time, if an amount of deflection is greater than a threshold deflection, the top portion may be resurfaced, replaced, etc. before being used to manufacturing additional part(s). The sensor(s) may therefore be used to track conditions experienced by the build plate, and/or whether the build plate needs to be resurface or replaced.

In some instances, passages, ports, channels, or receptacles may be formed in bottom portion and/or the top portion. For example, receptacles may be formed within the bottom portion and/or the top portion to receive the sensor(s). Moreover, in some instances, divots or protrusions may be formed within the top portion. In some instances, the divots or protrusions may help anchor the parts being made on the top portion. In some instances, the top portion may also be formed with strengthening ribs running in one direction or another (e.g., parallel to the direction of movement of the build module).

Stress-relieving features may also be formed within the top portion. These stress-relieving features may prevent fractures or deflections in the top portion during the cyclic heating and cooling of the top portion during manufacture of the part(s). In some instances, the stress-relieving features may be passages, grooves, slits, or other voids formed in the top portion (e.g., during manufacture). Moreover, in some instances, the top portion may be formed with markers that localize the lasers on the build plate. For example, markers or other datum points may be formed on the top surface of the top portion, and sensor(s) of the 3D printing system(s) may image the datum points for use in localizing the lasers and controlling the manufacturing process.

The use of the channel(s) in conjunction with the build plate may increase efficiencies in additive manufacturing. For example, the use of the channel(s) to cool the build plate may reduce deflections experienced by the build plate, which in turn, may lead to an increased use of the build plate without the need or frequency to resurface and/or replace the build plate. Additionally, less time and resources may be spent ensuring a planarity of the build plate for accurately and precisely manufacturing parts.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting examples. The features illustrated or described in connection with one example may be combined with the features of other examples. Such modifications and variations are intended to be included within the scope of the appended claims.

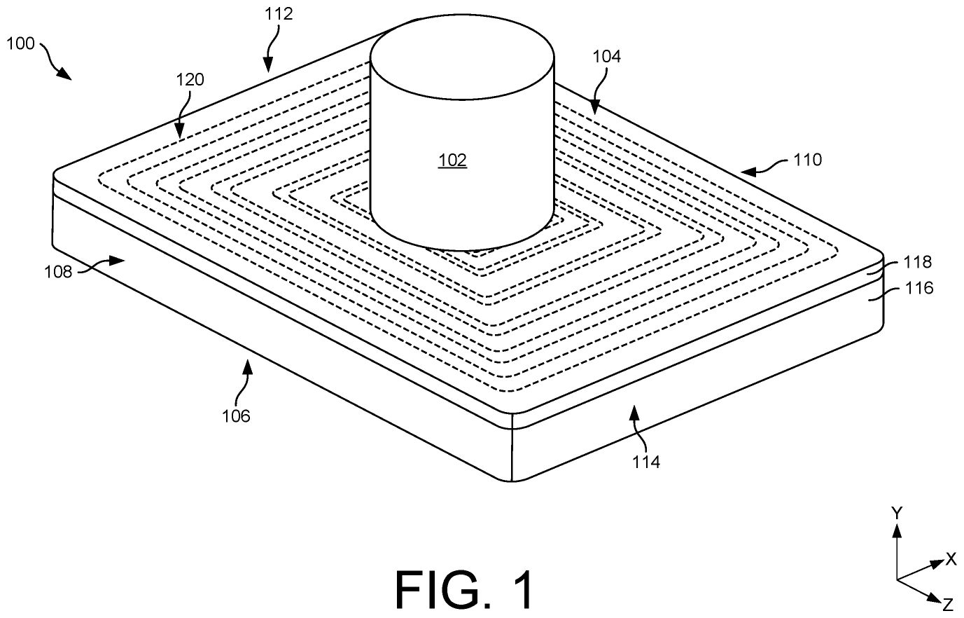

FIG. 1 illustrates a perspective view of an example build plate 100, according to examples of the present disclosure. In some instances, the build plate 100 is configured to reside within a build module (not shown) in which parts are manufactured using additive manufacturing. For example, the build plate 100 may provide a bed, or platform, on which a part 102 is manufactured.

The build plate 100 may include a top 104, a bottom 106 spaced apart from the top 104 (e.g., in the Y-direction), a first side 108, a second side 110 spaced apart from the first side 108 (e.g., in the X-direction), a third side 112, and a fourth side 114 spaced apart from the third side 112 (e.g., in the Z-direction). In some instances, the build plate 100 may include a rectangular shape. In such instances, the rectangular-shaped build plate 100 may be received with a rectangular-shaped cavity of the build module. However, the build plate 100 may include other shapes, such as being circular, ovular, hexagonal, and so forth.

In some instances, the build plate 100 includes a bottom portion 116 and a top portion 118. The bottom portion 116 may represent a first half, section, segment, etc. of the build plate 100, while the top portion 118 may represent a second half, section, segment, etc. of the build plate 100. The bottom portion 116 may be disposed along the bottom 106, while the top portion 118 may be disposed along the top 104. In some instances, the bottom portion 116 may represent a base of the build plate 100 that couples to a piston, or other lift mechanisms, for raising and lowering the build plate 100 within the build module. For example, as the part 102 is manufactured, layer by layer, the piston may lower the build plate 100 into the build module (e.g., in the Y-direction).

The top portion 118, as noted above, may represent a platform on which the part 102 is manufactured. For example, powdered metal may be deposited onto the top portion 118, and lasers may be steered or otherwise directed to certain locations to melt the powdered metal and form the part 102. Therein, additional layers of powdered metal may be deposited on the build plate 100, or the previously melted layers, and melted by the lasers. Although a single part 102 is shown being manufactured on the build plate 100, multiple parts may be manufactured on the build plate 100. The parts 102 may also take any size and shape.

In some instances, the top portion 118 may be formed on the bottom portion 116. For example, the top portion 118 may be formed, using additive manufacturing, on the bottom portion 116. In some instances, the bottom portion 116 may be formed from a piece of material (e.g., machined, milled, etc.), and thereafter, the top portion 118 may be manufactured on the bottom portion 116 (e.g., once the bottom portion 116is installed in the build module). Once the top portion 118 is manufactured, the powdered metal may be deposited onto the top portion 118 for manufacturing the part 102. In some instances, the bottom portion 116 may be formed of a first material, and the top portion 118 may be formed of a second material that is different than the first material. The materials of the bottom portion 116 and the top portion 118 may be metallurgically compatible such that the top portion 118 may be secured (e.g., adhered, bound, etc.) to the bottom portion 116 as the top portion 118 is formed on the bottom portion 116.

To account for heat generated during melting of the powdered metal to form the part, channel(s) 120 (e.g., conduits, ducts, tubes, etc.) may be formed within the top portion 118. The channel(s) 120 as illustrated in FIG. 1 are shown as dashed lines to indicate residing within the top portion 118. Additional details of the channel(s) 120 will be discussed herein. Coolant, gases, or other fluids may be routed through the channel(s) 120 to absorb heat during manufacturing of the part 102 and heat experienced by the build plate 100 (e.g., via the lasers). In some instances, the channel(s) 120 may be formed using additive manufacturing processes, while the top portion 118 is formed. That is, as the top portion 118 is formed, the channel(s) 120 may be formed within the top portion 118 to provide cooling effects to the build plate 100 (and/or the build module) as the part 102 is manufactured. As will be discussed herein, the channel(s) 120 may serpentine, zig-zag, or otherwise route within, throughout, etc. the top portion 118 (e.g., in the X and/or Z-direction) to absorb heat.

Although not show, in some instances, the top portion 118 may be formed with markers that localize the lasers on the build plate 100. For example, markers or other datum points may be formed on the top portion 118, and sensor(s) may image the datum points for use in localizing the lasers during manufacturing of the part 102.

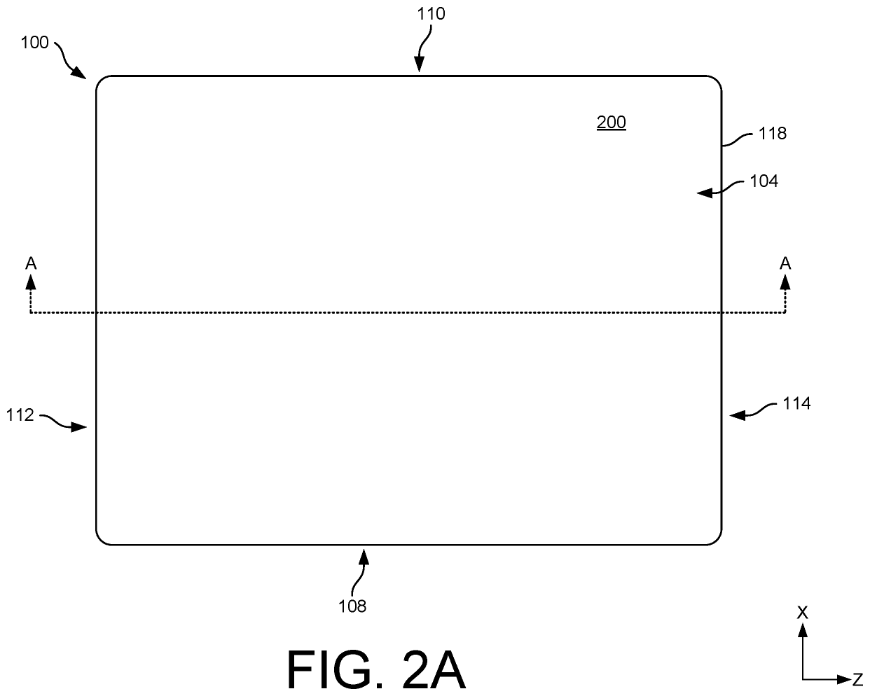

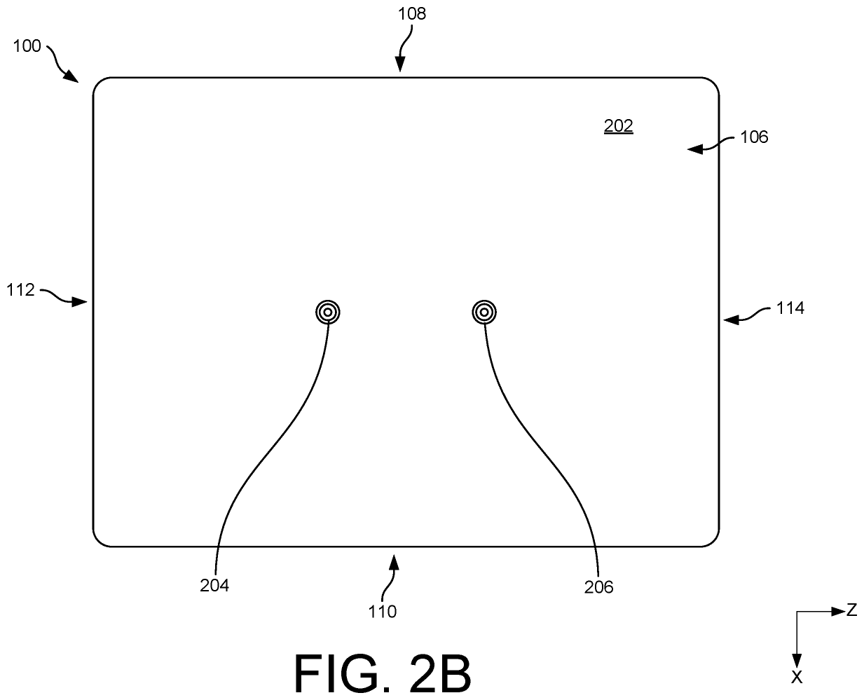

FIGS. 2A and 2B illustrate a top view and a bottom view of the build plate 100, respectively, according to examples of the present disclosure. The top 104 of the build plate 100 may be defined by a top surface 200 of the top portion 118. In some instances, the top surface 200 may be substantially planar (e.g., about the X-Z plane). As shown, the top portion 118 may be substantially rectangular in shape, however, other shapes are envisioned.

The bottom 106 of the build plate 100 may be defined by a bottom surface 202 of the bottom portion 116. In some instances, the bottom surface 202 may be substantially planar (e.g., about the X-Z plane). As shown, the bottom portion 116 may be substantially rectangular in shape. The bottom portion 116 may define an inlet 204 and an outlet 206. The inlet 204 may fluidly connect to a first pipe (e.g., conduit, duct, hose, etc.) and the outlet 206 may fluidly connect to a second pipe (e.g., conduit, duct, hose, etc.). The inlet 204 may route coolant into the channel(s) 120, while the outlet 206 may receive coolant from the channel(s) 120 (e.g., once routed throughout the channel 120).

Although the build plate 100 is shown including a single inlet and a single outlet, in some instances, the build plate 100 may include more than one inlet and/or more than one outlet. For example, to provide for different cooling effects and/or cooling to different areas of the build plate 100, more than one inlet and/or more than one outlet may be formed within the bottom portion 116. In some instances, the inlet 204 and/or the outlet 206 may be centrally located between the first side 108 and the second side 110. However, the inlet 204 and/or the outlet 206 may be located differently than shown on the bottom portion 116 (e.g., closer to the first side 108, on the first side 108, etc.).

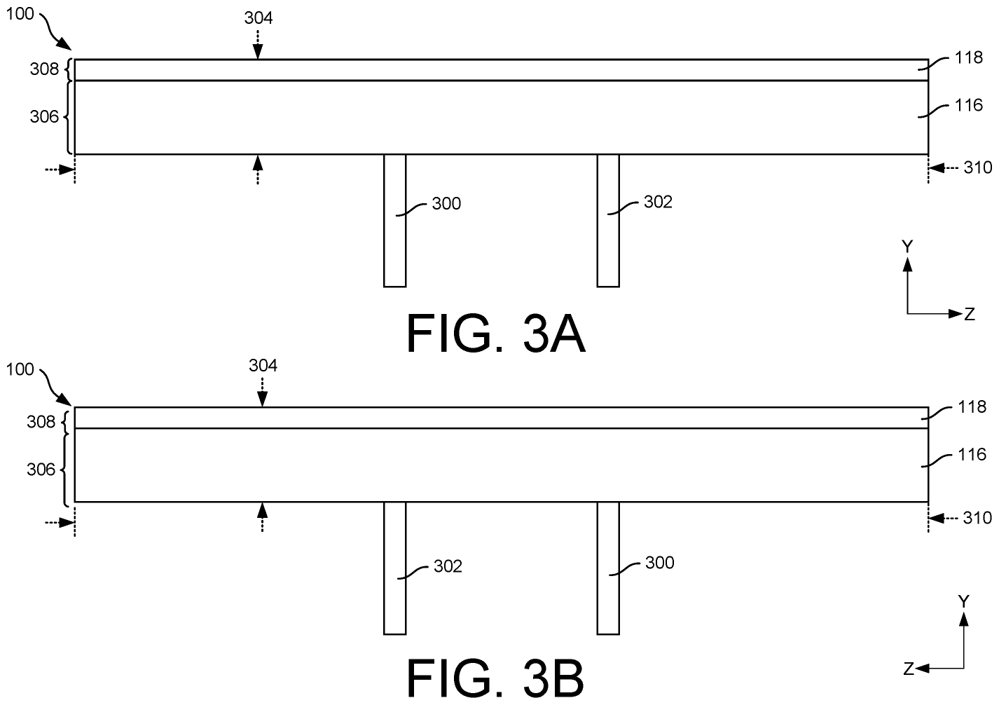

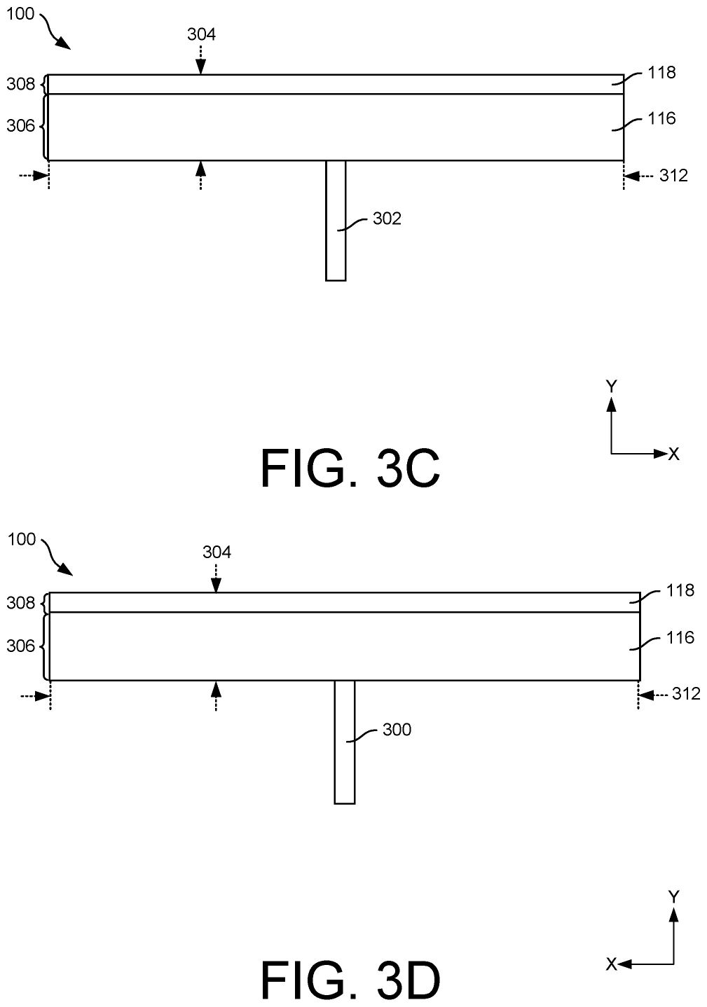

FIGS. 3A-3D illustrate side views of the build plate 100, according to examples of the present disclosure. A first pipe 300 may fluidly connect to the inlet 204 for providing coolant to the channel(s) 120, and a second pipe 302 may fluidly connect to the outlet 206 for receiving the coolant once routed through the channel(s) 120. The first pipe 300 and the second pipe 302 may include various couplings, seals, or gaskets for sealing to the inlet 204 and the outlet 206. Additionally, given that the build plate 100 may translate within the build module, (e.g., in the Y-direction) the first pipe 300 and/or the second pipe 302 may include sufficient slack, play, or relief to translate within the build module. Additionally, or alternatively, in some instances the first pipe 300 and/or the second pipe 302 may communicatively connected to one or more pipes, conduits, etc. that provide slack, play, or relief.

In some instances, the build plate 100 may include a thickness 304 (e.g., in the Y-direction) that extends between the top 104 and the bottom 106. The bottom portion 116 may include a first height 306 that forms a portion of the thickness 304, and the top portion 118 may include a second height 308 that forms a portion of the thickness 304. In some instances, the first height 306 is greater than the second height 308. Alternatively, the first height 306 may be less than or equal to the second height 308. As will be explained herein, the channel(s) 120 may be formed within the second height 308.

Additionally, the build plate 100 may include a length 310 (e.g., in the Z-direction), between the third side 112 and the fourth side 114. In some instances, the bottom portion 116 and the top portion 118 and may span the length 310. In some instances, the bottom portion 116 or the top portion 118 may span less than the length 310, or include different lengths. The build plate 100 may also include a width 312 (e.g., in the X-direction), between the first side 108 and the second side 110. In some instances, the top portion 118 and the bottom portion 116 may span the width 312. In some instances, the bottom portion 116 or the top portion 118 may span less than the width 312, or include different widths. In some instances, dimensions of the build plate 100 (e.g., the thickness 304, the first height 306, the second height 308, etc.) may be based at least in part on the part 102 being manufactured on the build plate 100.

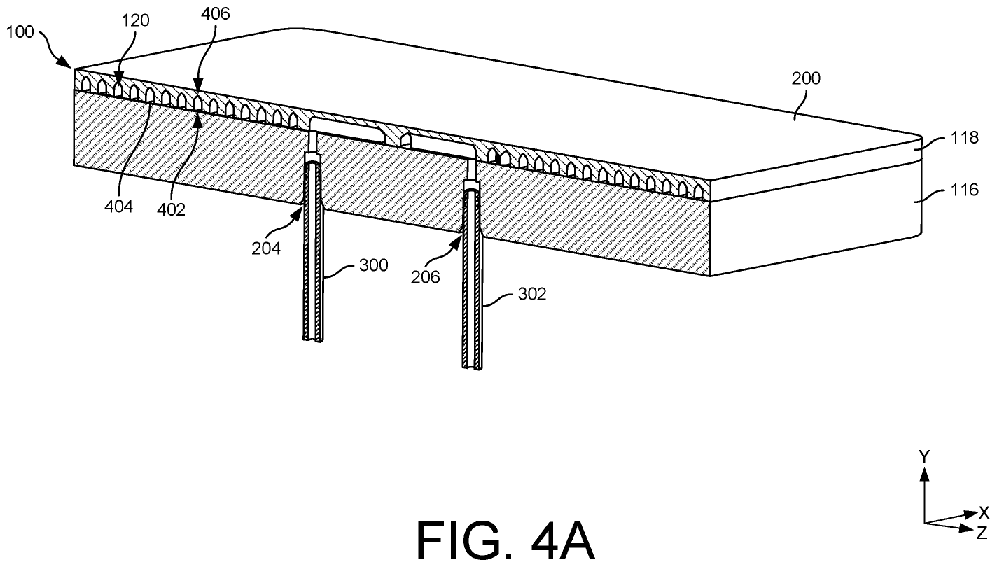

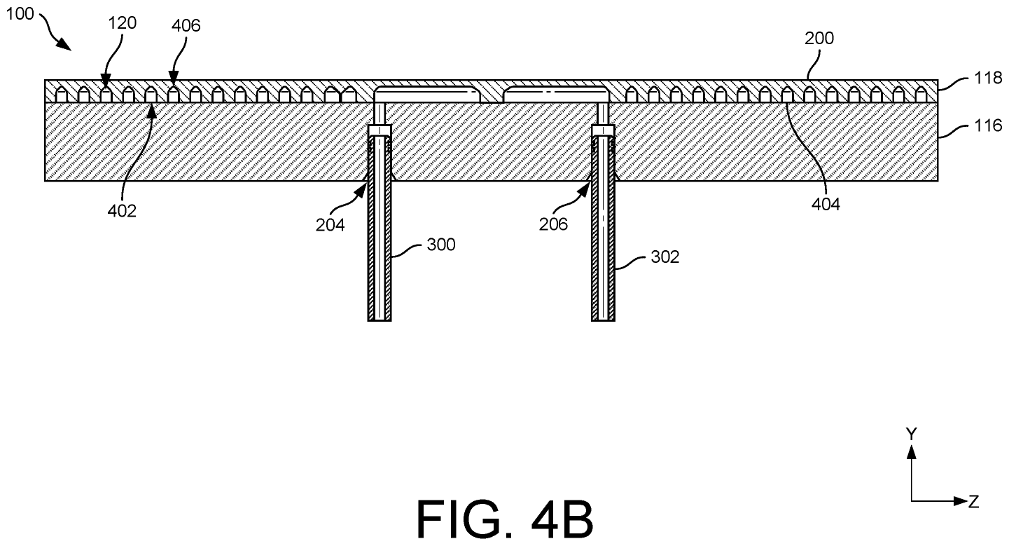

FIGS. 4A and 4B illustrate cross-sectional views of the build plate 100, taken along line A-A of FIG. 2A, according to examples of the present disclosure. The inlet 204 and the outlet 206 are formed within the bottom portion 116, and fluidly connect to the first pipe 300 and the second pipe 302, respectively.

The build plate 100 includes the channel 120 to provide cooling to the build plate 100 and/or the part 102 as the part 102 is manufactured. The channel 120 is formed within the top portion 118 (i.e., integral therewith), during a manufacture of the top portion 118 on the bottom portion 116. The channel 120 may extend from the inlet 204 to the outlet 206, along a serpentine, spiral, or radial path within the top portion 118. As such, as coolant enters the channel 120, the coolant may route throughout the top portion 118 and then out the outlet 206. In some instances, the channel 120 may be a continuous channel throughout the top portion 118, or multiple channels may be formed within the top portion 118. In some instances, the channel 120 may include a singular passage, or may fork, divide, etc. to include multiple passages throughout the top portion 118. In such instances, the multiple passages may convert to a single outlet 206, or multiple outlets 206.

In some instances, a bottom 402 of the channel 120 may extend from (or be disposed at) a top surface 404 of the bottom portion 116. A top 406 of the channel 120 may be spaced apart from the top surface 200 of the top portion 118 (e.g., in the Y-direction). The channel 120 may be formed directly on the top surface 404 of the bottom portion 116. However, in some instances, the bottom 402 of the channel 120 may be spaced apart from the top surface 404 of the bottom portion 116. For example, one or more layers of powdered metal may be melted on the top surface 404 of the bottom portion 116, and in such instances, the bottom 402 of the channel 120 may be defined by the previous layers of the melted powdered metal.

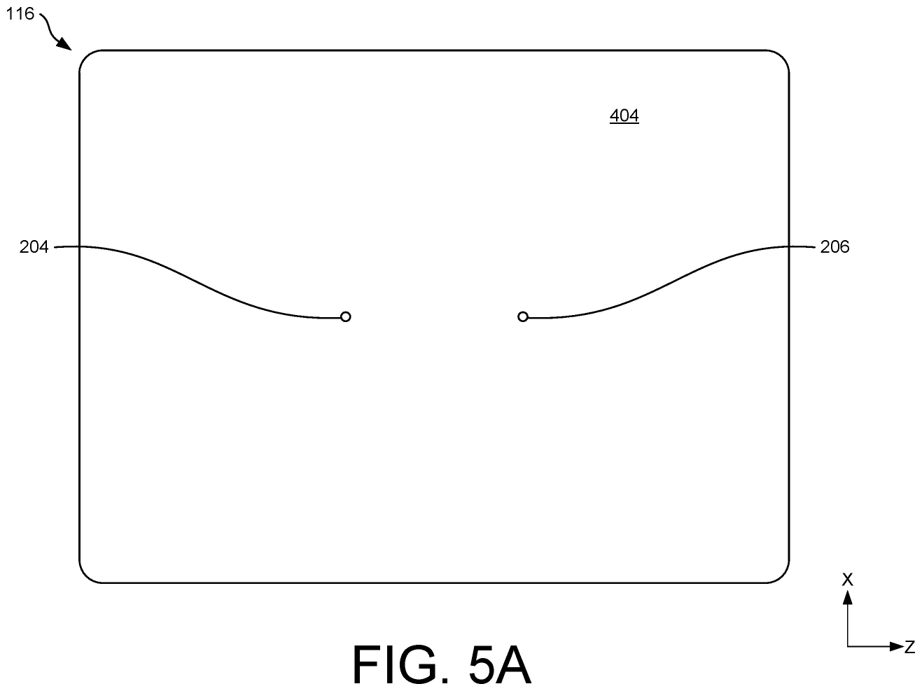

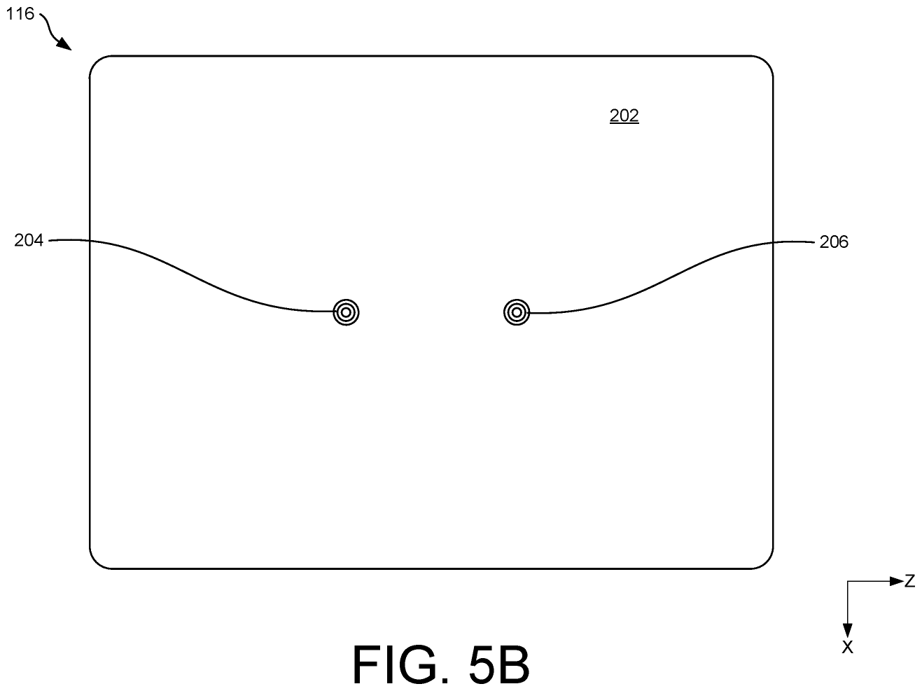

FIGS. 5A and 5B illustrate a top view and a bottom view of the bottom portion 116, respectively, according to examples of the present disclosure. The bottom portion 116 may have the top surface 404 onto which the top portion 118 is formed, and the bottom surface 202. The inlet 204 and the outlet 206 extend through the bottom portion 116 (e.g., in the Y-direction), through the first height 306, or between the bottom surface 202 and the top surface 404. The inlet 204 and the outlet 206 fluidly connect to the channel 120 (or ends of the channel 120) for routing coolant throughout the top portion 118. In some instances, the inlet 204 and the outlet 206 are circular in shape, however, other shapes are envisioned. Moreover, as discussed above, more than one inlet 204 and/or outlet 206 may be disposed through (or within) the bottom portion 116. The multiple inlets and/or outlets may connect to distinct channels, or the same channel. In some instances, the inlet 204 and/or the outlet 206 may include fittings for coupling to the first pipe 300 and the second pipe 302, respectively. In some instances, channel(s) may also be formed within the bottom portion 116, which may be fluidly connected to or separate from the channel 120.

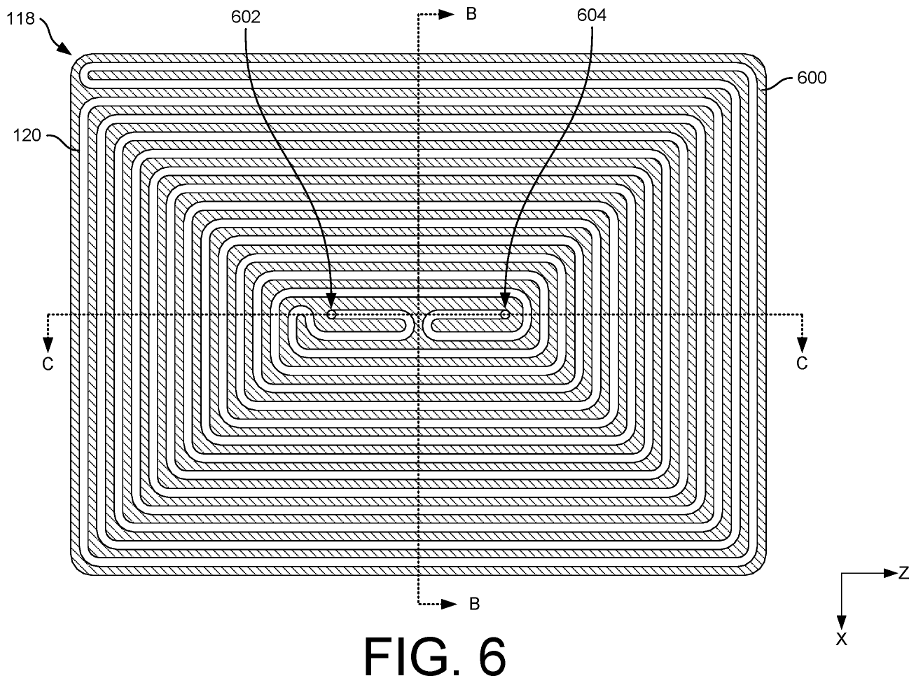

FIG. 6 illustrates the top portion 118, according to examples of the present disclosure. The channel 120 is shown formed within the top portion 118, between the top surface 200 of the top portion 118 and a bottom surface 600 of the top portion 118. The bottom surface 600 is formed on (e.g., extending from) the top surface 404 of the bottom portion 116.

The channel 120 includes a first end 602 and a second end 604. The first end 602 may fluidly connect to the inlet 204, while the second end 604 may fluidly connect to the outlet 206. When the top portion 118 is formed on the top surface 404 of the bottom portion 116, the first end 602 may be in fluid connection with the inlet 204 so as to receive the coolant, and the second end 604 may be in fluid connection with the outlet 206 so as to dispel the coolant. Between the first end 602 and the second end 604, the channel 120 may take a serpentine or spiral-like path throughout the top portion 118.

Although a particular path or shape of the channel 120 is shown, other embodiments are envisioned. For example, the channel 120 may take different paths through the top portion 118, may only be disposed on certain areas of the top portion 118, and so forth. In some instances, the channel 120 may be continuous between the first end 602 and the second end 604. However, in some instances, the channel 120 be discontinuous and/or more than one channel 120 may be formed within the top portion 118. In some instances, the different channels may have different lengths, shapes, configurations, and so forth. In some instances, the geometry, size, shape, and/or configuration of the channel(s) may be dependent upon the parts being manufactured.

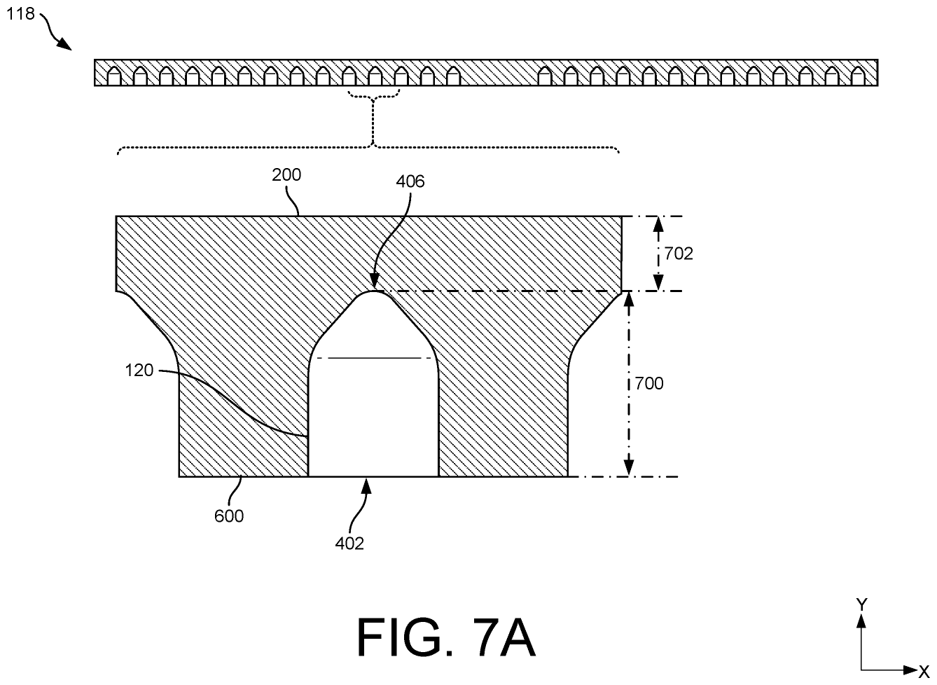

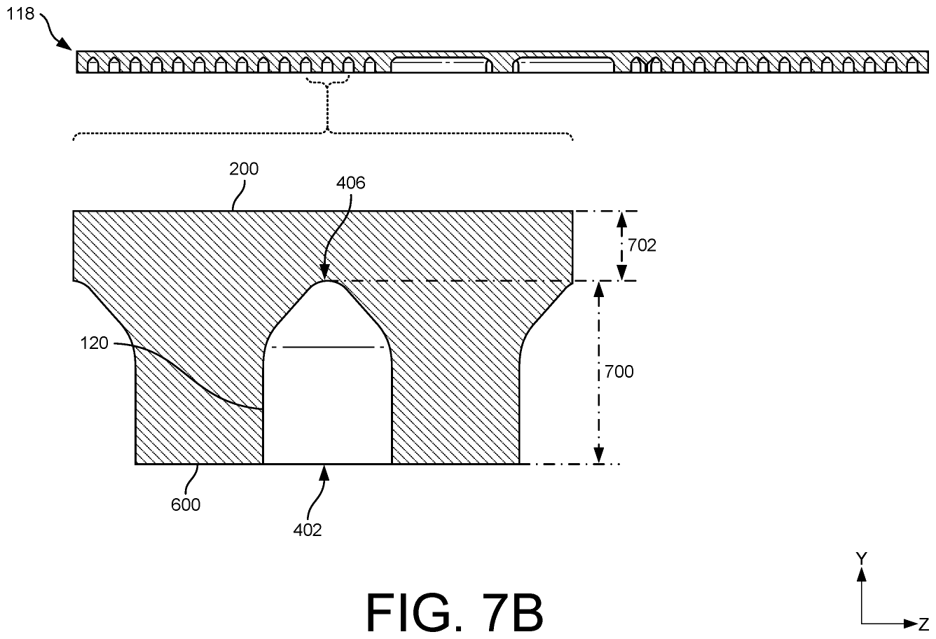

FIGS. 7A and 7B illustrate cross-sectional views of the top portion 118, according to examples of the present disclosure. FIG. 7A illustrates a cross-sectional view of the top portion 118 taken along line B-B of FIG. 6, and FIG. 7B illustrates a cross-sectional view of the top portion 118 taken along line C-C of FIG. 6.

In some instances, the channel 120 includes a height 700 that extends between the bottom 402 (or the top surface 404) of the channel 120 and the top 406 of the channel 120. The top 406 of the channel 120 may be spaced apart from the top surface 200 of the top portion 118 by a distance 702 to permit the top surface 200 to be machined or finished. For example, after manufacturing the part 102 on the top surface 200, portions of the top portion 118 (or the bottom portion 116) may deflect (e.g., in a bowl-like fashion). To make the top surface 200 planar for manufacturing another part, the top surface 200 may be machined. The distance 702 may be predetermined such that the top surface 200 may be machined without penetrating the channel 120. In some instance, the distance 702 may be predetermined such that the top surface 200 may be machined multiple times without penetrating the channel 120.

In some instances, however, rather than machining the top surface 200, another layer of material may be manufactured on the top surface 200, thereby creating a new top surface, in order for the top surface 200 to be machined and without penetrating the channel 120. Manufacturing another layer of material may also eliminate the need to machine the top surface 200, as the newly added layer may be made planar. The bottom 402 of the channel 120 may be disposed along the bottom surface 600 of the top portion 118. The top surface 404 of the bottom portion 116 may define the bottom 402 of the channel 120. As shown, portions of the top portion 118 are interposed between adjacent sections of the channel 120.

In some instances, the channel 120 includes planar sidewalls and a dome-shaped top. The geometry of the channel 120 may be capable of being manufactured via additive manufacturing. However, although a particular geometry (e.g., cross-section) of the channel 120 is shown, the channel 120 may include other geometries. For example, the channel 120 may be hexagonally shaped, square shaped, semi-circular shaped, etc. In some instances, the shape of the channel 120 may be based at least in part on specific(s) of the part 102 being manufactured. Moreover, different portions (e.g., lengths) of the channel 120 may be shaped differently, for example, to provide different cooling effects to different portions of the build plate 100.

In some instances, the top portion 118 may include stress-relieving features. These stress-relieving features may be formed during manufactured of the top portion 118 and may prevent fractures or deflections in the top portion 118 during the cyclic heating and cooling of the top portion 118. In some instances, the stress-relieving features may be passages, grooves, or other voids formed in the top portion 118. In some instances, the stress-relieving features may be interposed between adjacent sections of the channel.

Additionally, the bottom portion 116 and/or the top portion 118 may be formed with other passages, ports, or receptacles. For example, receptacles may be formed within the bottom portion 116 and/or the top portion 118 for receiving temperatures sensors, strain gauges, vibration sensor(s), or other type of sensor(s). These sensor(s) may be used to measure a temperature associated with manufacturing the part 102, a temperature of the top surface 200 of the top portion 118, a temperature of the coolant within the channel 120, a deflection of the build plate 100, or other characteristic(s) of the build plate 100 or the build module. In some instances, sensor data (e.g., feedback) generated by the sensor(s) may be used to control one or more operations, such as adjusting a flow rate of the coolant through the channel 120, reducing an intensity of the lasers melting the powdered metal, and so forth.

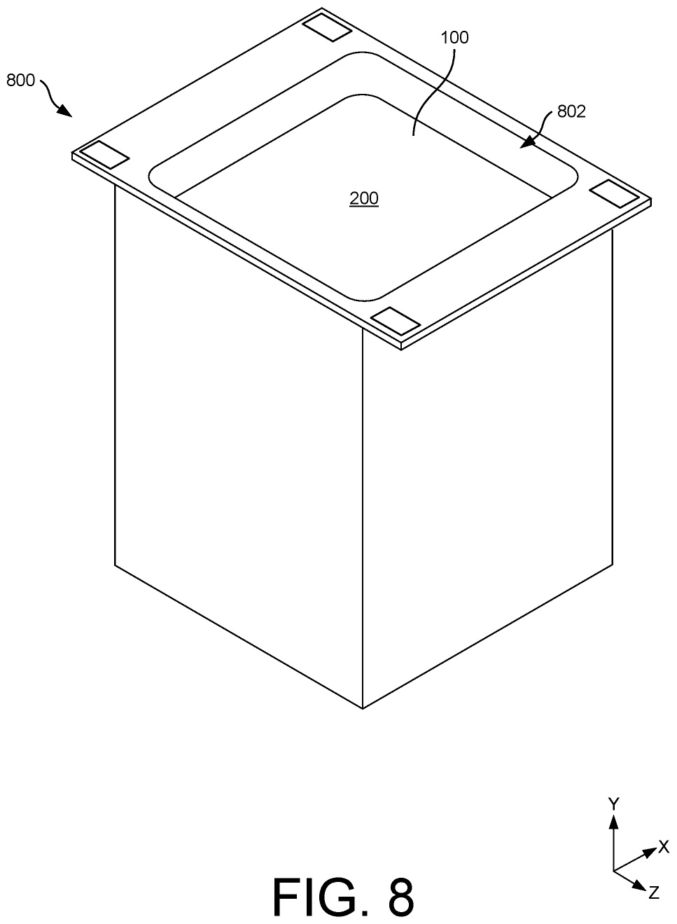

FIG. 8 illustrates an example build module 800, according to examples of the present disclosure. The build module 800 may define a cavity 802 in which the build plate 100 is capable of being received. For example, the part 102 may be manufactured on the build plate 100, within the cavity 802. Lasers from a lasing module, for example, are directed to portions of the build plate 100 containing the powdered metal for forming the part 102. For example, powdered metal may be deposited onto the build plate 100, and the lasers may be directed towards the powdered metal on the build plate 100. Additionally, as layers of the part are manufactured, the build plate 100 may retract into the build module 800 such that additional layers of the part are capable of being manufactured (e.g., in the Y-direction). A piston, for example, may operably couple to the build plate 100 for lowering the build plate 100 into the cavity 802, in a direction towards the bottom.

While a certain shape of the build module 800 is shown, other shapes are envisioned. In some instances, the cavity 802 may be differently shaped as shown, and in such instances, the build plate 100 may be correspondingly shaped. Additional details of the build plate are described in, for example, U.S. patent application Ser. No. 17/944,901, filed Sep. 14, 2022, entitled “3D Printing System within Moving Build Module,” the entirety of which is herein incorporated by reference. Additionally, an example 3D printing system that the build module 800 may be used in conjunction with is described in, for example, U.S. patent application Ser. No. 17/944,883, filed Sep. 14, 2022, entitled “Lasing Module for 3D Printing System,” the entirety of which is herein incorporated by reference.

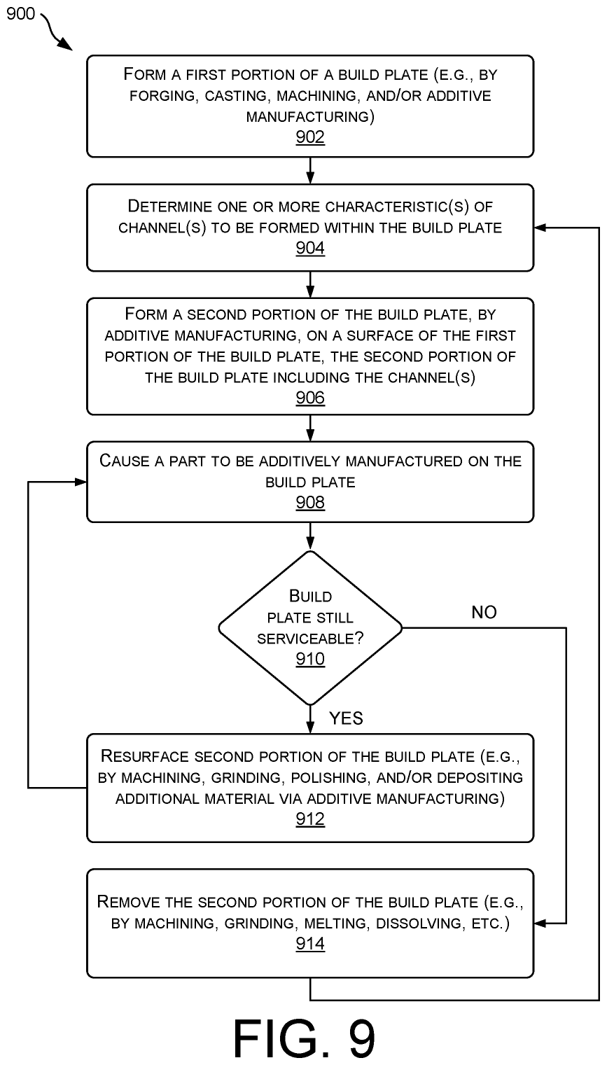

FIG. 9 illustrates an example process 900 related to forming channel(s) within a build plate, according to examples of the present disclosure. The process 900 described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process 900, or alternative processes, and not all of the blocks need be executed. For discussion purposes, the process 900 are described with reference to the environments, devices, architectures, diagrams, and systems described in the examples herein, such as, for example those described with respect to FIGS. 1-8, although the process 900 may be implemented in a wide variety of other environments, architectures, and systems.

At 902, the process 900 may include forming a first portion of a build plate. For example, the bottom portion 116 of the build plate 100 may be formed via forging, casting, machining, and/or additive manufacturing. The bottom portion 116 may be formed of a first material, such as Inconel 718. The bottom portion 116 may also be formed with one or more inlets and one or more outlets for routing coolant into and receiving coolant from, the channels 120, as will be discussed herein.

At 904, the process 900 may include determining one or more characteristic(s) of channel(s) to be formed within a build plate. In some instances, the one or more characteristic(s) may include a geometry of the channel(s) 120, a shape of the channel(s) 120, a size of the channel(s) 120, an area on the build plate 100 on which the channel(s) 120 are to be manufactured, a number of the channel(s) 120 to be manufactured, and so forth. In some instances, the characteristic(s) may be based at least in part on the part 102 being manufactured, such as a lasing intensity of the laser(s), a type of powdered metal to be melted to form the part 102, a size of the part 102, and so forth.

At 906, the process 900 may include forming a second portion of the build plate. For example, the top portion 118 of the build plate 100, with the channel(s) 120 therein, may be manufactured on the bottom portion 116. In some instances, the top portion 118 may be formed using additive manufacturing techniques such that the top portion 118 is formed directly on the bottom portion 116. In some instances, the material that the top portion 118 is manufactured from may be based at least in part on the material of the bottom portion 116, a type of powdered metal to be melted on the build plate 100, and so forth.

For example, for the top portion 118 to be adhered to the bottom portion 116 of the build plate 100, two metallurgically compatible materials may be used. As an example, if the bottom portion 116 is made from Inconel 718, the top portion 118 may be made from 316L stainless steel. In addition, for the part 102 to be manufactured on the top portion 118, the material of the top portion 118 may be metallurgically compatible with the powdered metal used to form the part 102.

In some instances, in addition to forming the channel(s) 120 within the top portion 118, stress-relieving features and/or receptacles may be formed within the top portion 118. For example, sensor(s) may be disposed in the receptacles for monitoring manufacturing of the part 102. The sensor(s) may also indicate the stresses and/or strains experienced by the build plate 100, the part 102, etc.

At 908, the process 900 may include causing a part to be manufactured. For example, once the channel(s) 120 are formed within the build plate 100, the build plate 100 may be used to manufacture the part 102. In some instances, the top portion 118 may be finished prior to being used to manufacture parts, for example, to ensure a planarity of the top portion 118 (e.g., the top surface 200). As the part 102 is manufactured on the build plate 100, coolant may be supplied throughout the channel(s) 120. In some instances, the flow rate of coolant throughout the channel(s) 120 may be based on temperatures associated with manufacturing the part 102. Moreover, the sensor(s) disposed within the build plate 100 may be used to monitor the part 102 being manufactured, and feedback from the sensor(s) may be used to control setting(s) during manufacturing.

At 910, the process 900 may include determining whether the build plate is still serviceable. Whether the build plate 100 is serviceable may include determining a deflection of the build plate 100 that occurred while forming the part 102 (e.g., at 908). That is, after the part 102 is manufactured and/or removed, a planarity of the top portion 118 may be determined. In some instances, sensor(s) (e.g., camera(s), strain gauge(s), etc.)) may be used to determine an amount of deflection of the top portion 118 or the top surface 200 on which the part 102 was manufactured. If the top surface 200 has deflected, or is rough (e.g., bumps), for example, the top surface 200 may not provide a sufficient surface upon which another part is to be manufactured. In some instances, whether the build plate 100 is still serviceable may also be based at least in part on an number of times, an amount of use, and so forth of the build plate 100. Moreover, whether the build plate 100 is still serviceable may be based at least in part on the channel(s) 120 being suitable for manufacturing of another part. For example, the channel(s) 120 may not include characteristic(s) (e.g., size) for manufacturing of a second part. If at 910 the build plate 100 is still serviceable, the process 900 may follow the “YES” route and continue to 912.

At 912, the process 900 may include resurfacing the build plate. For example, after the part 102 is manufactured, and the part 102 is removed, the top surface 200 of the top portion 118 may be ground to be planar. During the manufacturing of the part 102, the top portion 118 may deflect and resurfacing the top portion 118 may make the top portion 118 planar again for manufacturing another part. In some instances, rather than grinding the top surface 200, new material may be added to the top surface 200 of the top portion 118 (i.e., to build up another layer). Moreover, only a portion of the build plate 10 may be resurfaced. From 912, the process 900 may loop to 908, where another part may be manufactured.

In some instances, rather than resurfacing the build plate 100, the build plate 100 may be heated to correct any planarity or distortion issues. For example, being as the bottom portion 116 may be manufactured from a higher strength material as compared to the top portion 118, during reheating, the top portion 118 may yield to the bottom portion 116. In other words, because Inconel 718 has a higher strength at elevated temperatures compared to 316L stainless steel, during reheating of the build plate 100, the material of the top portion 118 would lose strength before the material of the bottom portion 116, thereby allowing the bottom portion 116 to “straighten out” (i.e., be planar). During this process, the material of the top portion 118 would yield to the material of the bottom portion 116.

Alternatively, if at 910 the build plate 100 is not serviceable, the process 900 may follow the “NO” route and continue to 914. At 914, the process 900 may include removing the second portion of the build plate. For example, the top portion 118 of the build plate 100 may be removed via machining, grinding, etc. In some instances, only a portion of the top portion 118 may be removed. From 914, the process 900 may loop to 904, whereby another top portion 118 may be formed for manufacturing additional parts.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A build plate comprising:
a bottom portion including:
a first bottom surface,
a first top surface,
a first passage disposed between the first bottom surface and the first top surface, and
a second passage disposed between the first bottom surface and the first top surface; and
a top portion formed on the first top surface of the bottom portion, the top portion including:
a second top surface,
a second bottom surface, and
one or more channels located between the second bottom surface and the second top surface.

2. The build plate of claim 1, wherein the one or more channels are fluidly connected to the first passage and the second passage.

3. The build plate of claim 1, wherein the top portion is formed on the bottom portion using additive manufacturing.

4. The build plate of claim 1, wherein:
the bottom portion is made of a first material; and
the top portion is made of a second material that is different than the first material.

5. The build plate of claim 4, wherein the first material has a higher strength than the second material.

6. The build plate of claim 1, wherein the second top surface forms a build area on which powdered metal is deposited for manufacturing one or more parts.

7. A build module comprising:
a cavity; and
a build plate disposed within the cavity, the build plate including:
a bottom portion, and
a top portion formed on the bottom portion, the top portion including:
a top surface,
a bottom surface, and
one or more channels located between the bottom surface and the top surface, the one or more channels to receive coolant to provide cooling to one or more parts manufactured on the build plate.

8. The build module of claim 7, wherein the top portion is additively manufactured on the bottom portion.

9. The build module of claim 7, wherein the bottom portion includes:
a first passage fluidly connected to the one or more channels; and
a second passage fluidly connected to the one or more channels.

10. The build module of claim 7, wherein the one or more channels include:
a first channel, and
a second channel fluidly separate from the second channel.

11. The build module of claim 7, wherein a characteristic of the one or more channels is based at least in part on the one or more parts.

12. The build module of claim 7, wherein:
the bottom portion is manufactured from a first material; and
the top portion is manufactured from a second material different than the first material.

13. The build module of claim 7, further comprising one or more sensors configured to generate sensor data associated with manufacturing the one or more parts.

14. A method comprising:
forming a first portion of a build plate;
determining one or more characteristics of a channel to be formed within a second portion of the build plate;
forming the second portion of the build plate, by additive manufacturing, on a surface of the first portion of the build plate, the second portion of the build plate including the channel; and
causing a part to be additively manufactured on the build plate.

15. The method of claim 14, further comprising:
determining that the build plate needs to be resurfaced; and
causing the build plate to be resurfaced.

16. The method of claim 14, further comprising receiving, from one or more sensors, sensor data associated with the part being additively manufactured, and wherein determining that the build plate needs to be resurfaced is based at least in part on the sensor data.

17. The method of claim 14, further comprising:
determining that the second portion of the build plate needs to be removed;
causing the second portion of the build plate to be removed; and
forming a third portion of the build plate, by additive manufacturing, on the surface of the first portion of the build plate.

18. The method of claim 14, wherein the first portion is formed of a first material having a first strength, and the second portion is formed of a second material that has a second strength less than the first strength.

19. The method of claim 18, further comprising heating the build plate to correct a distortion of the build plate caused during manufacturing of the part, wherein during heating of the build plate, the second material of the second portion yields to the first material of the first portion.

20. The method of claim 14, further comprising causing coolant to be supplied to the channel during manufacturing of the part.
